(19) United States
(12) Patent Application Publication
(10) Pub. No.: US 2012/0051842 A1
(43) Pub. Date: Mar. 1, 2012

(54) FIRE RESISTANT OIL SPILL BARRIER

(76) Inventor: Peter Lane, Orchard Park, NY (US)

(21) Appl. No.: 13/221,018

(22) Filed: Aug. 30, 2011

Related U.S. Application Data
(60) Provisional application No. 61/378,275, filed on Aug. 30, 2010.

(51) Int. Cl. E02B 15/06; B23P 25/00

(52) U.S. Cl. 405/63; 29/458

(57) ABSTRACT

A fire-resistant barrier for the containment of marine oil spills having a first and second end, a length of interwoven high-temperature resistant yarns and metallic wires, coated with a high-temperature resistant synthetic polymeric resin connecting the first and second ends, a plurality of fire-resistant buoyancy devices and a tension member connecting the first end to the fire-resistant buoyancy devices most proximate the first end.

### FIELD OF THE INVENTION

This invention relates to floating oil spill barriers and in particular relates to a fire-resistant, buoyant, oil spill barrier for the containment of marine oil spills.

### BACKGROUND OF THE INVENTION

One method to clean marine oil spills is to burn off the oil sitting on the surface of the water. If the oil is dispersed, it may be necessary to first concentrate the oil by skimming the surface of the water to bring a more concentrated amount of oil into a particular region. Also, because burning the oil in an uncontrolled manner is dangerous, it is important that the fire be contained.

Therefore, a fire-resistant device for concentrating and containing oil is desired.

Further, a flexible fire-resistant device that is resistant to tearing is desired.

### SUMMARY OF THE INVENTION

The invention comprises, in one form thereof, a fire-resistant, portable, barrier for the containment of marine oil spills. The barrier being a continuous length of a fire-resistant fabric having two ends with interwoven yarns of heat-resistant material, coated with a liquid-impermeable film between the two ends. The fabric being impermeable to a hydrocarbon petroleum oil. Buoyant bodies are attached to the fabric to buoy the length of fabric on a body of water and a stiffening member connects one end of the fire-resistant fabric to the buoyant body most proximate to that end. A means for stabilizing the length of fabric when buoyed upon the body of water is attached to the barrier.

The term “high temperature resistant” as used herein means the material, resin or yarn will not significantly degrade after exposure to temperatures of at least 400° F. to 500° F. for extended periods of time.

The term “fire-resistant” as used herein means the barrier will resist failure for a minimum of 12 hours when exposed to open flame fueled by a petroleum oil.

An advantage of the present invention is that it is functional, durable, and reusable a number times.

### BRIEF DESCRIPTION OF THE DRAWINGS

The present invention is disclosed with reference to the accompanying drawings, wherein:

FIG. 1 is a isometric view of a fire-resistant barrier according to one embodiment;

FIG. 2 is a side view of the fire-resistant barrier as shown in FIG. 1;

FIG. 3 is view along the line A-A of FIG. 2;

FIG. 4 is a side view of a fire-resistant barrier having a stiffening member attached to the fabric according to one embodiment;

FIG. 5 is a side view of a fire-resistant barrier having a stiffening member attached to one end and a buoyant body according to one embodiment;

FIG. 6 is side view of a fire-resistant barrier having a cable attached to the top surface according to one embodiment;

FIG. 7 is a magnified view of the circled region A of FIG. 6;

FIG. 8 is a magnified view of the circled region B of FIG. 6;

FIG. 9 is a side view of the fabric and buoyant bodies according to one embodiment; and

FIG. 10 is a magnified view of a portion of the woven fabric component.

Corresponding reference characters indicate corresponding parts throughout the several views. The examples set out herein illustrate several embodiments of the invention but should not be construed as limiting the scope of the invention in any manner.

### DETAILED DESCRIPTION

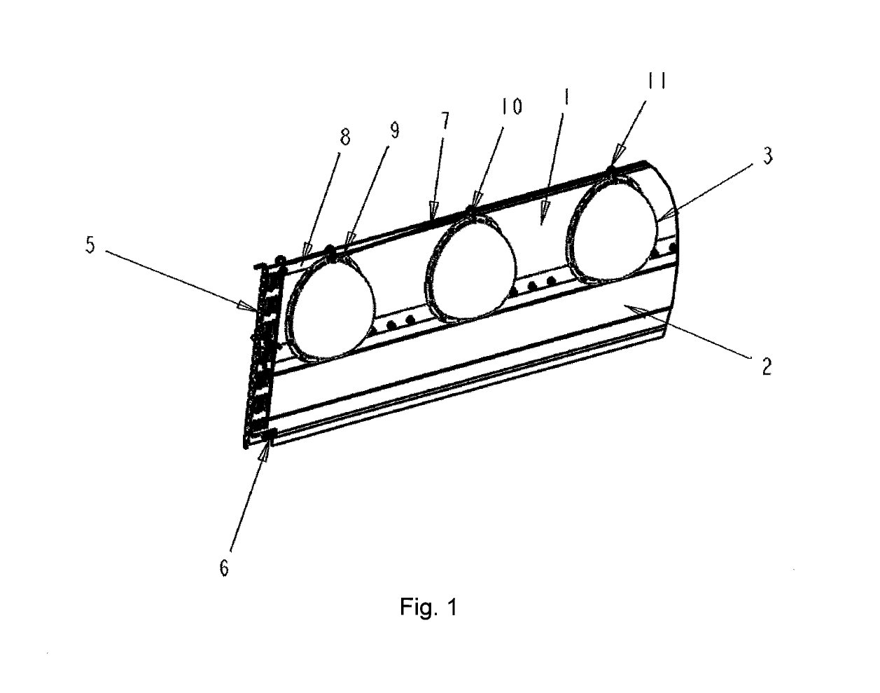

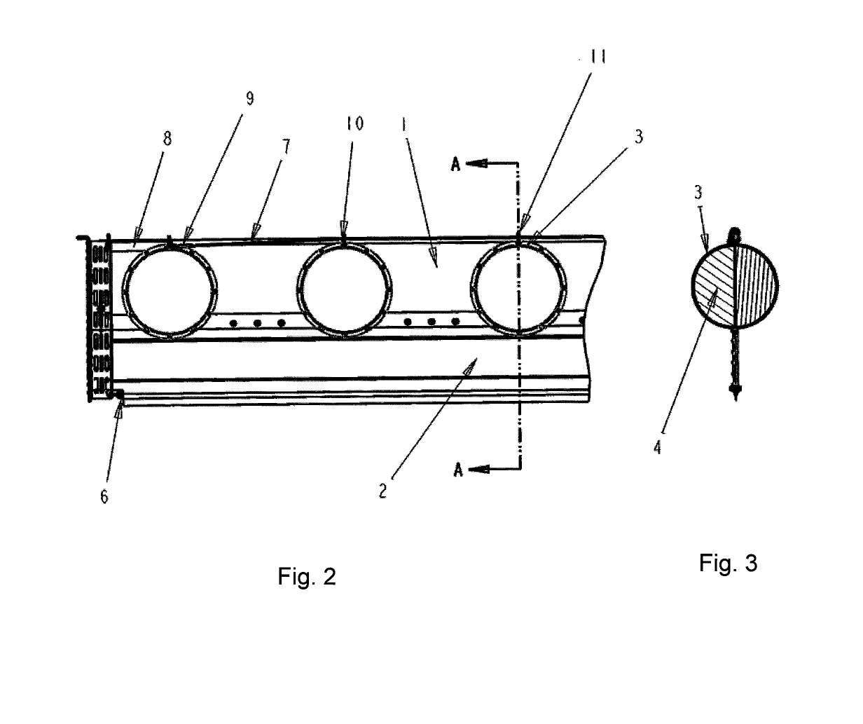

Referring to FIGS. 1-3, there is shown the fire-resistant barrier according to one embodiment of the present invention. The fire-resistant barrier 100 includes a fire-resistant fabric 1, a number of buoyant bodies 3, two end connectors 5, and a stiffening member 8. The fire-resistant barrier 100 is an elongated, length of a textile, fire-resistant fabric 1. When placed in a body of water, a ballast chain 6 and a cable tension member 7 stabilize the fire-resistant barrier 100 to form a barrier both above and below the surface of the water. It is understood that the ballast chain and cable tension member are interchangeable and either may be used to provide tension and thereby stabilize the fire-resistant barrier. The fire-resistant barrier may contain any number of ballast chains or cable tension members to achieve the desired tension and stabilization.

The fire-resistant fabric 1 is flexible. Allowing for the fabric to flex allows for the fire-resistant barrier to take on many shapes in the water. The fire-resistant barrier 100 may be fashioned to restrict and contain an oil spill of any configuration upon the surface of a body of water. Also, the flexibility enables one to draw the fire-resistant barrier onto a reel for fast and easy deployment of the barrier.

A plurality of buoyant bodies 3 are spaced apart along the fire-resistant fabric 1 to float the fire-resistant barrier 100 in water. The surface of the buoyant bodies is constructed of a fire-resistant material such as stainless steel. In one embodiment, to increase the buoyancy, the buoyant bodies are hollow, closed steel hemispheres filled with a buoyant high temperature resistant material 4 in sufficient volume to buoy the entire fire-resistant barrier 100. In addition to increasing buoyancy, the buoyant high temperature resistant material 4 is also resistant to deformation when subjected to high temperatures.

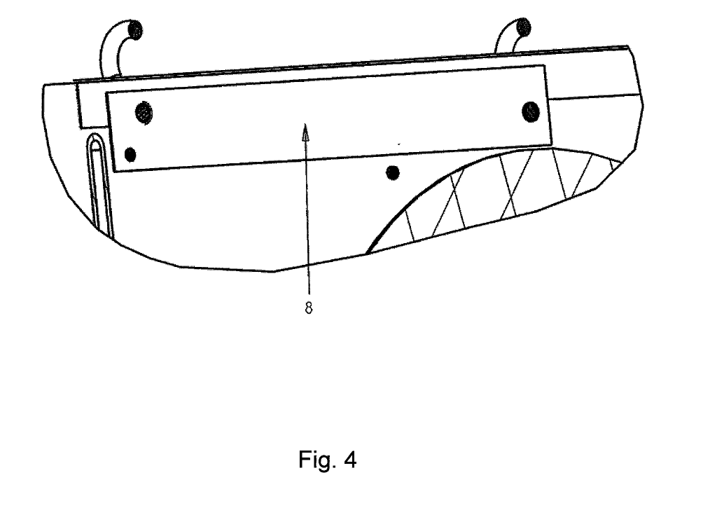

The buoyant bodies 3 may be affixed to the fire-resistant fabric 1 in any suitable manner. In one embodiment, the two hemispheres of the buoying bodies 3 are bolted together through the fabric to form a more spherical shape as shown in FIG. 3. In another embodiment, the buoyant bodies 3 are connected by means of a flange or yoke attached to the fabric. It will be understood to those skilled in the art that the buoyant bodies 3 may be attached in various manners to achieve the desired construction.

Within the buoyant bodies 3 are a buoyant high temperature resistant material 4. Because the buoyant high temperature resistant material is enclosed within the buoyant bodies 3, it is not necessary to be fire-resistant. However, because of the high temperatures, it is important that the buoyant high temperature resistant material retain its buoyant properties during use. In one embodiment, the buoyant high temperature resistant material 4 is a foamed glass having a specific gravity that is less than the specific gravity of water. In another embodiment, the buoyant high temperature resistant material 4 is a syntactic foam or a synthetic polymeric resin having a specific gravity that is less than the specific gravity of water.

Synthetic polymeric resins include, but are not limited to polyurethanes, polyesters, polyepoxides and the like; co-polymer resins such as styreneacrylonitrile and the like; and polyester resins such as those described in U.S. Pat. No. 4,104,357, the contents of which are incorporated by reference.

In one embodiment, syntactic foams are hardened, synthetic polymeric resins loaded or filled with a plurality of microspheres. Methods of manufacturing syntactic foams are well known and described in U.S. Pat. Nos. 3,353,981; 3,230,184; and 3,622,437, the contents of each are hereby incorporated by reference. In general, syntactic foams are hardened or cured synthetic, polymeric resins filled or loaded with hollow, closed microspheres, as defined by the ASTM Committee on Syntactic Foam. The microspheres not only act as fillers, but also reduce the overall density of the foam. The microspheres may be fabricated from glass, ceramic, polymeric resins and like materials; see U.S. Pat. Nos. 2,797,201 and 3,133,821, the contents of both which are hereby incorporated by reference. In one embodiment, the microsphere are represented by the commercially available “Glass Bubbles” (3M Corporation, St. Paul, Minn.). In one embodiment, the microspheres have diameters of 5 to 500 microns.

The microspheres being contained within the buoyant body increase the overall buoyancy of the device. It is understood that a mixture of high temperature resistant material may be used to blend the properties of each fill material. In one embodiment microspheres as described above make up 50 to 75% of the total volume of the buoyant high temperature resistant material.

To reduce costs, the fire-resistant barrier 100 may utilize the fire-resistant fabric 1 above the surface of the water and a neoprene coated sub-surface skirt 2 below the surface of the water. In use, the neoprene coated sub-surface skirt 2 is located under the surface of the water and therefore protected by the water itself. Thus this portion of the fire-resistant barrier may be constructed from a distinct material, which can be a lower cost material.

At each end of the fire-resistant barrier 100 an end connector 5 is attached to the fire-resistant fabric 1. The end connector 5 provides an attachment point for the effective use of the fire-resistant barrier 100. The end connectors 5 allow multiple fire-resistant barriers to be connected together. Alternative, the end connector is attached to a distinct type of boom or connected directly to a tow vessel. It is understood that the end connector 5 may also be attached to a distinct fabric located under the surface of the water. In an alternative embodiment, a number of end connectors are attached to the distinct fabrics.

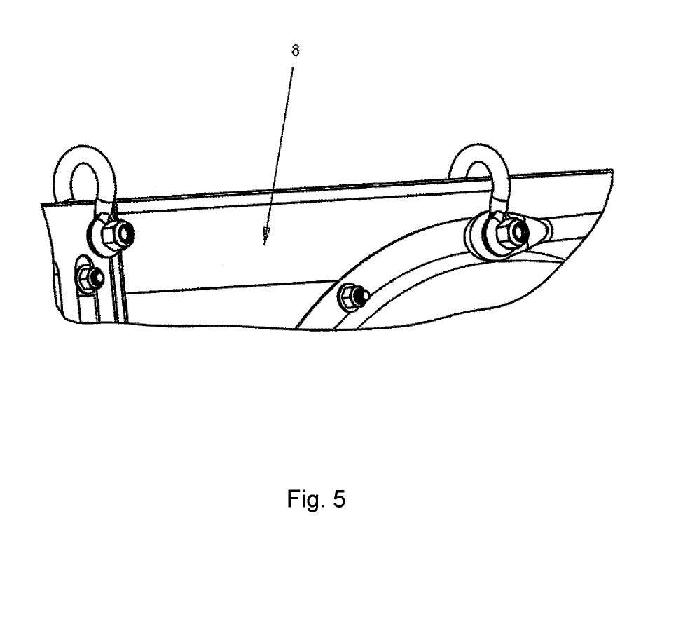

Referring to FIGS. 4-5, there is shown a stiffening member 8 in detail. Due to towing forces, wind and turbulent water, the fire-resistant barrier 100 will move when positioned in the water. This causes the fabric to bend and fold. Because the end connector is generally a straight edge, as opposed to the round edges around the buoyant bodies, the portion of the fire-resistant fabric 1 near the end connector 5 is subject to flex fatigue, tearing, ripping or other failures. These type of failures are most common along a straight edge, such as that along the end connector 5. To reduce these failures, a stiffening member 8 is positioned between the end connector 5 and the buoyant body 3 closest to the end connector 5. The stiffening member 8 limits the amount of flex in the fire-resistant barrier 100 between the end connector 5 and the buoyant body most proximate to that end connector. In one embodiment the stiffing member is constructed of stainless steel.

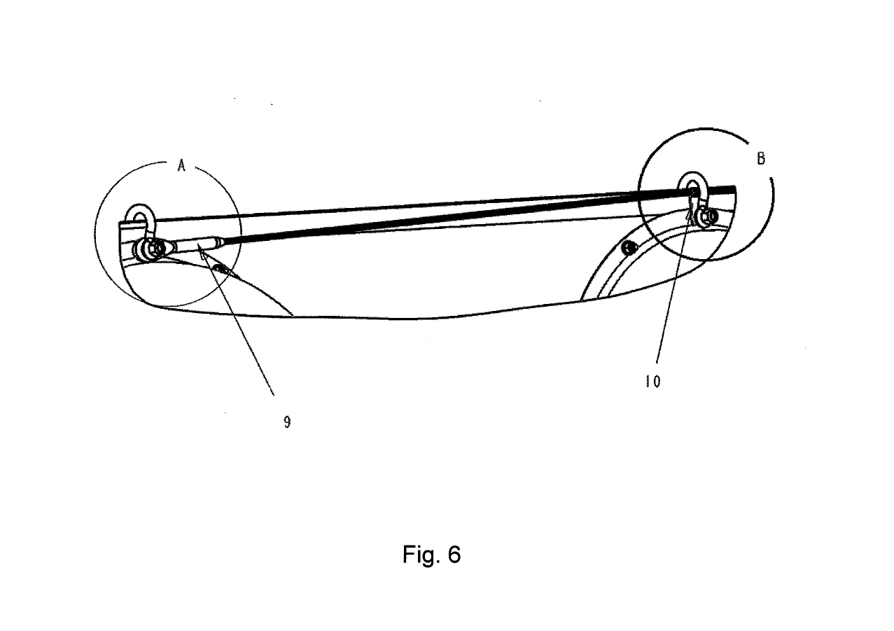

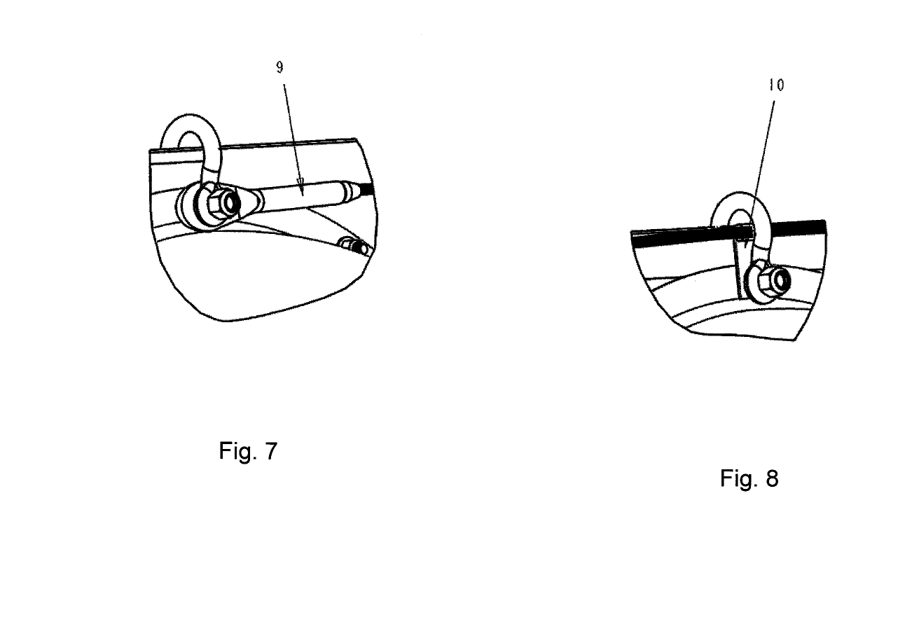

In one embodiment, the stiffening member 8 is affixed to the upper portion of the fire-resistant fabric 1. The stiffening member 8 is sufficiently held in place by the attachment of the end connector 5 and the buoyant body 3. Referring to FIGS. 6-8, in an alternative embodiment, the stiffing member 8 is affixed by means of the cable retaining clip 10. As shown in FIG. 7, the stiffening member 8 is affixed to the fire resistant-fabric 1 by means of the cable retaining clip 10. It is understood that the stiffening member 8 can be positioned and attached by any suitable means and this embodiment is not intended as limiting. For example, in other embodiments the stiffening member is not only at the top of the fabric but also extends further from the top of the fabric. In one embodiment the stiffening member extends to the bottom of the fabric. In another embodiment, the stiffening member extends about half way down the fabric.

The cable retaining clip 10 allows for attachment of the cable tension member 7 to the eyelet 11. In one embodiment, the cable tension member 7, attaches to the upper portion of the fire-resistant barrier 100 by means of a swage end eye fitting 9. The cable tension member 7 assists in retaining proper tension on the fire-resistant barrier 100 in use. It is understood that the cable tension member can be affixed and connected by any suitable means.

Referring to FIG. 10 the fire-resistant fabric 1 is made from interwoven yarns of heat resistant materials. The interwoven yarns 13 are woven together in a weave density that inhibits the permeability of the fire-resistant fabric 1 to hydrocarbon petroleum oils. The fire-resistant fabric 1 is coated to both protect the interwoven yarns 13 and to make the fire-resistant fabric 1 impermeable to hydrocarbon petroleum oils. In one embodiment the coating is a synthetic polymeric resin that works in conjunction with the weave of the fabric to obtain the desired oil impermeability. The coating need only cover the interwoven yarns 13 and does not need to be coated onto the area under the buoyant bodies 3 or the portion of the fabric submerged under the water.

To render the fire-resistant fabric 1 impermeable to the passage of hydrocarbon petroleum oil, freely floating on a body of water, the fire-resistant fabric 1 is coated in a high temperature resistant resin. Suitable high temperature resistant resins include, but are not limited to polysulfones, organopolysilicones, polyphenylene sulfide, polyepoxides, polyesters, polyester-imide, polyamide-imide, polyimides, polyquinozalines, mixtures thereof and like high temperature resistant resin. It is understood that the various resins may be applied in separate coating layers or as mixtures.

In one embodiment the coating is between 2.5 to 15 of the total weight of the fire-resistant fabric. In another embodiment, the coating is between 2.5 to 5 of the total weight of the fire-resistant fabric. The coatings may be applied by any method known in the art, such as curtain spray, dipping and doping methods.

The interwoven yarns 13 may be any high-temperature resistant yarns. High-temperature resistant yarns include multifilament yarns of glass, carbon, aramid, polybenzimidazole, polyoxyadiazole fibers, mixtures thereof and the like; spun yarns from staple fibers include fibers of aramid, ceramic, novaloid and blends thereof spun into yarns; composite yarns such as is described in the U.S. Pat. No. 4,159,618, the contents which are hereby incorporated by reference; yarns prepared from fibers of the polyamide polymer of m-phenylenediamine and isophtaloyl chloride (commercially available under the trade name “Nomex” from E.I. DuPont de Nemours and Co.) or from fibers of poly(p-phenylene terephthalamide) which are also commercially available under the trademark “Kevlar” from E.I. DuPont de Nemours and Co.; composite yarns of a high-tensile strength core covered with a braid of high temperature resistant, synthetic polymeric resin filaments. In one embodiment, the composite yarns are prepared by braiding a polyamide fiber multifilament yarn, such as one within the scope of those described above over a core material. Core materials include fiberglass, E glass and like fibers; metal wires such as Chromel R, Rene 41, Halstelloy B, phosphor bronze and the like; and combinations of the above. In one embodiment, the core material is a bundle of fiberglass (multifilament glass yarns) with a single strand of phosphorous bronze wire. Additional, interwoven yarns include, a weavable metal and inorganic refractory fibers such as yarns of Fiberfrax, available from Sohio Resistant Materials, Co., Niagara Falls, N.Y. In one embodiment, the interwoven yarns are warp yarns of Iconel wire and filling yarns of a blend of Iconel and Fiberfrax.

The interwoven yarns 13 have a denier from about 200 to about 2,000 denier. In one embodiment, the interwoven yarns 13 are woven into a conventional weave pattern, preferably a plain or basket weave. In one embodiment, the interwoven yarns 13 are made to have a fabric weight of from about 45 to about 60 ozs. per square yard.

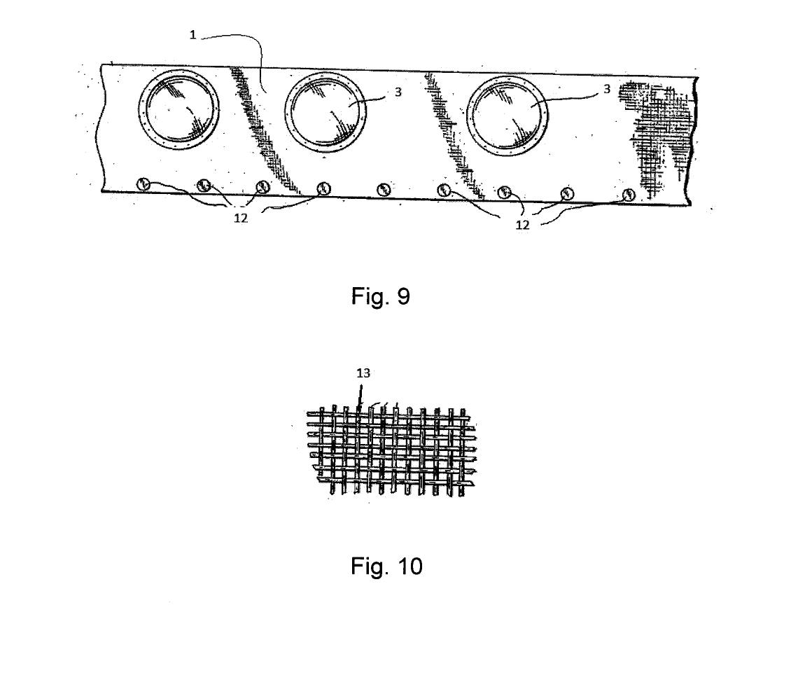

Referring to FIG. 9, there is shown an alternative embodiment of the fire-resistant barrier. As opposed to using a lower tension member, such as a ballast chain, a number of weights 12 are attached. The weights 12 assist in stabilizing the fire-resistant barrier in the water. It is understood that the weights may be attached by any suitable means.

The following example describes the manner and process of making and using the invention and sets forth the best mode contemplated by the inventor for carrying out the invention but are not to be considered as limiting the scope of the invention.

### EXAMPLE

A woven fabric is provided, characterized by its fire resistance light weight and durability. The fabric has a warp of 100% Iconel Wire and a filling of a blend of Iconel and Fiberfrax. The wire serves to provide support to the fabric structure while exposed to fire, and also has very good tensile strength properties, even at elevated temperatures. The “wire screen effect” of the interwoven wires helps to maintain integrity even after prolonged fire exposure. The Fiberfrax filling material is a stuffer yarn to help the wire screen remain impermeable after exposure to burning. It also provides a base for a polymeric resin coating to adhere to.

The fabric is coated in a conventional manner with a high-temperature resistant polyimide resin (2.5 to 4.0% weight add on). The barrier is prepared by mechanically attaching a 12″ wide strip of the fabric to a non-fireproof fabric, which serves to provide a below the waterline barrier. Identical hemispherical floats are mechanically attached to the fabric through holes provided on the flange of the float shells. The barrier is also provided with ballast and quick acting end connectors so that it can be used much like any conventional oil spill barrier. A stiffening member is attached between the end connectors and the hemispherical float closest to the end connector.

The barrier fabricated in accordance with this example, when floated on a water surface has a draft of 20 inches, a freeboard of 10 inches, an overall height of 30 inches and a weight of 8 to 10 lbs/linear feet. The coated barrier fabric has a tensile strength of 1000 lbs/inch and a tear strength of 500 lbs/in. The barrier, deployed to contain a petroleum oil spill on fire, will do so for a minimum of 12 hours before failure (exposure to temperatures of up to 2400° F.).

The barrier may be deployed generally downwind of an oil spill, according to generally accepted practices. An advantage of this barrier, is that it may be used to completely isolate an oil spill that is going to be burned for disposal, rather than recovery. While burning, the barrier is used to control the burning oil and reduce the available spreading area of the oil while it is burning.

After the fire is out, the barrier can be recovered and repaired so that it can be put back in service. The design of this barrier is such that the above-surface refractory fabric is replaceable by removing the fasteners that connect it to the below-surface portion of the barrier and to the floats.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

### PARTS LIST

1—fire-resistant fabric
2—sub-surface skirt
3—buoyant body
4—buoyant high temperature resistant material
5—end connector
6—ballast chain
7—cable tension member
8—stiffening member
9—end eye fitting
10—cable retaining clip
11—eyelet
12—weight
13—interwoven yarns
100—fire-resistant barrier

1. A fire-resistant, portable, barrier for the containment of marine oil spills, comprising:
a length of fire-resistant fabric comprising interwoven yarns of heat-resistant material, coated with a liquid-impermeable film and having a first end, said fire-resistant fabric being impermeable to hydrocarbon petroleum oil;
an end connection attached to said first end of said length of fire-resistant fabric;
a plurality of buoyant bodies attached to said fire-resistant fabric in a quantity and at positions sufficient to buoy the length of fire-resistant fabric on a body of water, one of said buoyant bodies being most proximate to said end connection; and
a stiffening member extending from said end connection to said buoyant body most proximate said end connection.

2. The fire-resistant, portable, barrier of claim 1 wherein said fire-resistant fabric comprises interwoven yarns of a metal wire and filler yarns of inorganic refractory fibers.

3. The fire-resistant, portable, barrier of claim 1 further comprising a means for stabilizing said length of said fire-resistant fabric when buoyed upon said body of water.

4. The fire-resistant, portable, barrier of claim 3 wherein said means for stabilizing includes the attachment of weights to said fire-resistant fabric.

5. The fire-resistant, portable, barrier of claim 3 wherein said means for stabilizing includes the use of a ballast chain.

6. The fire-resistant, portable, barrier of claim 1 further comprising a neoprene coated sub-surface skirt attached to a lower portion of said length of fire-resistant fabric.

7. The fire-resistant, portable, barrier of claim 1 wherein said liquid-impermeable film is a film of a heat-resistant, synthetic, polymeric resin.

8. The fire-resistant, portable, barrier of claim 1 wherein the buoyant bodies are steel hemispheres filled with a high-temperature resistant buoyancy filler material.

9. The fire-resistant, portable, barrier of claim 8 wherein the filler material is a foamed glass.

10. The fire-resistant, portable, barrier of claim 8 wherein the filler material is a syntactic foam.

11. The fire-resistant, portable, barrier of claim 1 wherein the stiffening member is a stainless steel stiffening member and is attached proximate an upper portion of the length of fire-resistant fabric.

12. The fire-resistant, portable, barrier of claim 11 wherein the steel stiffening member is generally rectangular in shape.

13. The fire-resistant, portable, barrier of claim 1 wherein the end of the stiffening member proximate the buoyant buoy is arc shaped to match the curvature of said buoyant buoy.

14. The fire-resistant, portable, barrier of claim 1 wherein the stiffening member extends from the upper surface of said length of fire-resistant fabric and past at least a midpoint of said length of fire-resistant fabric.

15. The fire-resistant, portable, barrier of claim 1 wherein the coating is between 2.5 to 5 of the total weight of the fire-resistant fabric.

16. The fire-resistant, portable, barrier of claim 1 wherein said length of fire-resistant fabric has an overall height of 30 inches.

17. The fire-resistant, portable, barrier of claim 1 wherein said length of fire-resistant fabric has a tensile strength of at least 1000 lbs/inch and a tear strength of at least 500 lbs/in.

18. The fire-resistant, portable, barrier of claim 1 wherein said length of fire-resistant fabric can withstand a 2400° F. for at least 12 hours prior to failure.

19. A method for manufacturing a fire-resistant, portable, barrier for the containment of marine oil spills, comprising the steps of:
providing a length of fire-resistant fabric comprising interwoven yarns of heat-resistant material having a first end;
coating said length of fire-resistant fabric with a liquid-impermeable film making said fire-resistant fabric impermeable to hydrocarbon petroleum oil;
providing a stiffening member proximate to said first end of said length of fire-resistant fabric;
attaching an end connection to said first end of said length of fire-resistant fabric and said stiffening member; and
attaching a plurality of buoyant bodies to said fire-resistant fabric in a quantity and at positions sufficient to buoy the length of fire-resistant fabric on a body of water, one of said buoyant bodies being most proximate to said end connection, where said buoyant body most proximate to said end connection connects said stiffening member to said fire-resistant fabric.

20. A method for manufacturing a fire-resistant, portable, barrier for the containment of marine oil spills, comprising the steps of:
providing a length of fire-resistant fabric comprising interwoven yarns of heat-resistant material having a first end;
coating said length of fire-resistant fabric with a liquid-impermeable film making said fire-resistant fabric impermeable to hydrocarbon petroleum oil;
attaching an end connection to said first end of said length of fire-resistant fabric; and
attaching a plurality of buoyant bodies to said fire-resistant fabric in a quantity and at positions sufficient to buoy the length of fire-resistant fabric on a body of water, one of said buoyant bodies being most proximate to said end connection;
attaching a stiffening member having a first and second end, with said first end of said stiffening member being proximate to said first end of said length of fire-resistant fabric and said second end of said stiffening member being proximate the buoyant body most proximate to said end connection.
